(19) United States
(12) Patent Application Publication
(10) Pub. No.: US 2010/0052997 A1
(43) Pub. Date: Mar. 4, 2010

(54) ANTENNA MODULES AND PORTABLE ELECTRONIC DEVICES USING THE SAME

(75) Inventors: SHIH-TSUNG KAN, Tu-Cheng (TW); CHIA-HONG LIN, Tu-Cheng (TW); CHANG-HSIN KUO, Tu-Cheng (TW); WEN-HSIU HSU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/260,878

(22) Filed: Oct. 29, 2008

(30) Foreign Application Priority Data
Aug. 29, 2008 (TW) 97133127

(51) Int. Cl. H01Q 1/38; H01Q 1/24; H01Q 1/12

(52) U.S. Cl. 343/702; 343/700 MS; 343/878

(57) ABSTRACT

An antenna module includes an antenna set, a feeding point and a ground plane. The antenna set includes a first antenna, and a second antenna. The first antenna has a first resonant frequency and the second antenna a second resonant frequency.

### BACKGROUND

1. Field of the Disclosure

The disclosure relates to an antenna module, and specifically to a dual band antenna module and a portable electronic device using the same.

2. Discussion of the Related Art

Radiotelephones typically include an antenna for transmitting and receiving wireless communications signals. Conventionally, external monopole and dipole antennas have been widely used in various radiotelephone applications, due to their simplicity, wideband response, broad radiation pattern, and low cost. However, the external antennas' susceptibility to damage by external force can result in operation deterioration. Furthermore, radiotelephones must meet demands for reduced size and profile. As such demand grows, the design of hidden antennas has become increasingly popular, with equal diligence afforded to retention and promotion of signal strength and stability.

Additionally, it is becoming desirable for radiotelephones to operate within multiple frequency to utilize more than one communication system. Consequently, high and low frequency antennas are often used together in cellular phones. FIG. 1 shows a contemporary internal antenna 10 comprising a first meandering portion 11 and a second meander-shaped portion 12. The first meander-shaped portion 11 has a first resonant frequency and the second meander-shaped portion 12 has a second resonant frequency. Thus, the antenna 10 can utilize two different frequency bands.

Unfortunately, the disclosed antenna is susceptible to interference from electromagnetic waves. As a consequence, the antennas are normally oriented away from circuit boards of the cellular phones. However, this makes minimizing the volume of radiotelephones difficult.

Therefore, there is room for improvement within the art.

### BRIEF DESCRIPTION OF THE DRAWINGS

Many aspects of the antenna module can be better understood with reference to the following drawings. The components in the drawings are not necessarily to scale, the emphasis instead being placed upon clearly illustrating the principles of the present antenna module. Moreover, in the drawings, like reference numerals designate corresponding parts throughout the several views, in which:

FIG. 1 is an isometric view of a contemporary internal dual band antenna module;

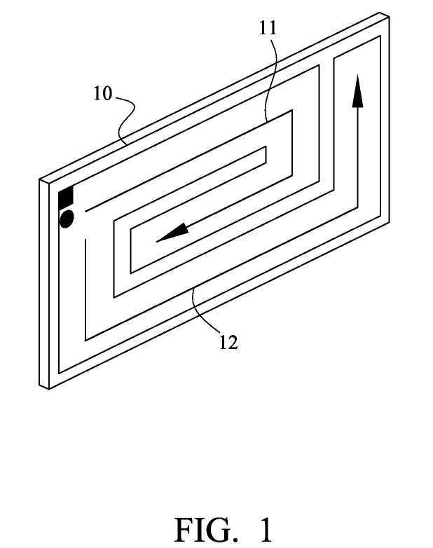

FIG. 2 is an isometric view of a portable electronic device, utilizing the antenna module according to an exemplary embodiment;

FIG. 3 is similar to FIG. 2, but viewed from another perspective;

FIG. 4 is a top view of an antenna module according to an exemplary embodiment;

FIG. 5 is an isometric view of a portable electronic device equipped with an antenna module according to an exemplary embodiment;

FIG. 6 shows return loss measurement for the antenna module in FIG. 5 in a closed state, wherein the x-axis indicates frequency and the y-axis indicates decibel (dB); and

FIG. 7 shows the return loss measurement for the antenna module in FIG. 5 in an opened state, wherein the x-axis indicates frequency and the y-axis indicates decibel (dB).

### DETAILED DESCRIPTION OF THE EMBODIMENTS

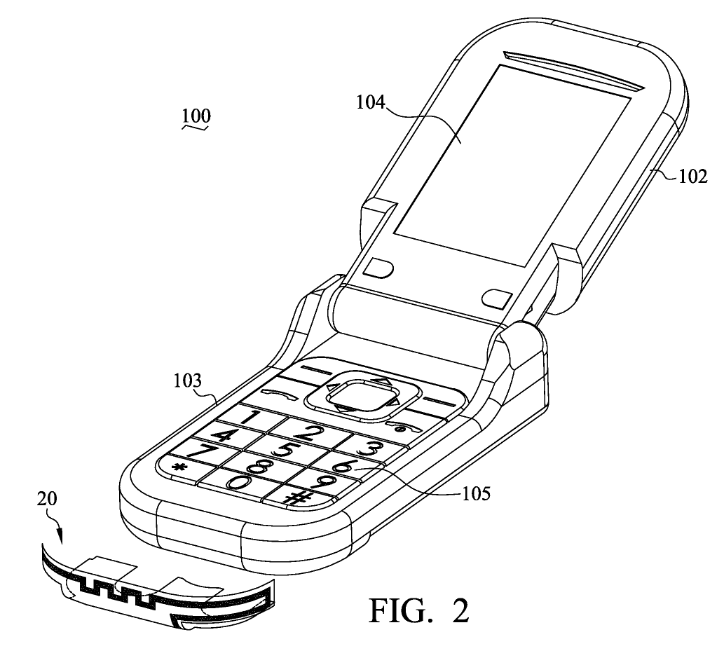

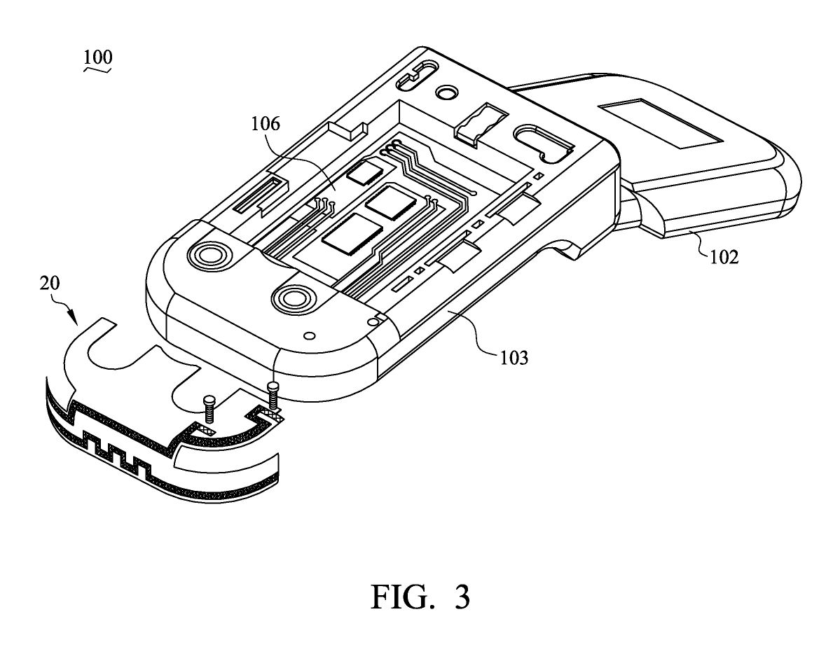

FIGS. 2 and 3 show a portable electronic device 100 including a flip cover 102 and a main body 103 connected to the flip cover 102 by a hinge. The flip cover 102 includes a display panel 104. The main body 103 includes a keypad 105, a circuit board 106 arranged under the keypad 105 and an antenna module 20 arranged on the bottom of the main body 103 electrically connecting to the circuit board 106.

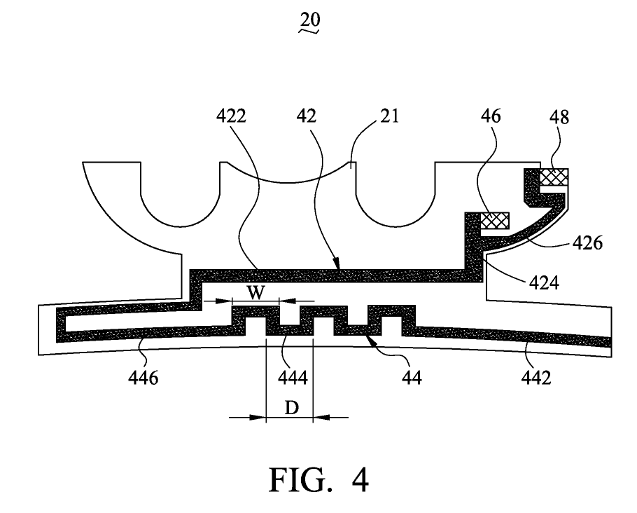

Referring to FIG. 4, the antenna module 20 includes a holder 21 supporting a first antenna 42, a second antenna 44, a feed point 46 and a ground 48 thereon.

In the exemplary embodiment, the first antenna 42 and the second antenna 44 are microstrip lines mounted on the holder 21. The second antenna 44 is located below the first antenna 42 and connected to an end of the first antenna 42. The feed point 46 and ground 48 are arranged on the holder 21 and electrically connected to the other end of the first antenna 42.

The first antenna 42 is a low frequency antenna and the second antenna 44 is a high frequency antenna. The first antenna 42 connects to the second antenna 44 so the two antennas form a single route dual-band monopole antenna.

The first antenna 42 includes a main portion 422, a first connecting portion 424 and a second connecting portion 426. The main portion 422 is mainly a long straight conductive strip. The first connecting portion 424 extends from an end of the main portion 422 and is mounted on the holder 21 so that the first connecting portion 424 connects to the feed point 46. The second connecting portion 426 extends from the first connecting portion 424 and is mounted on the holder 21 in a meandering structure. In addition, the other end of the second connecting portion 426 electrically connects to the ground 48 arranged on the surface of the holder 21.

The second antenna 44 includes a front section 442, a coupling section 444 and a bent section 446. The front section 442 is arranged parallel to the main portion 422 of the first antenna 42. The coupling section 444 extends from an end of the front section 442 as a meandering structure. The meandering structure of the coupling section 444 includes periodically spaced undulations. While, in the illustrated embodiment, each of the periodically spaced undulations has an inverted-U configuration, the meandering structure may follow virtually any type of undulation, without limiting the scope of the disclosure. The width W of each inverted-U portion is preferably equal to the distance D between each inverted-U portion. In alternative embodiments, different meandering structures can provide different coupling effect between the inverted-U portions to change the resonant frequency of the second antenna 44. The bent section 446 of the second antenna 44 extends from the other end of the coupling section 444. The bent section 446 connects the main portion 422 of the first antenna 42 and the coupling section 444 of the second antenna 44.

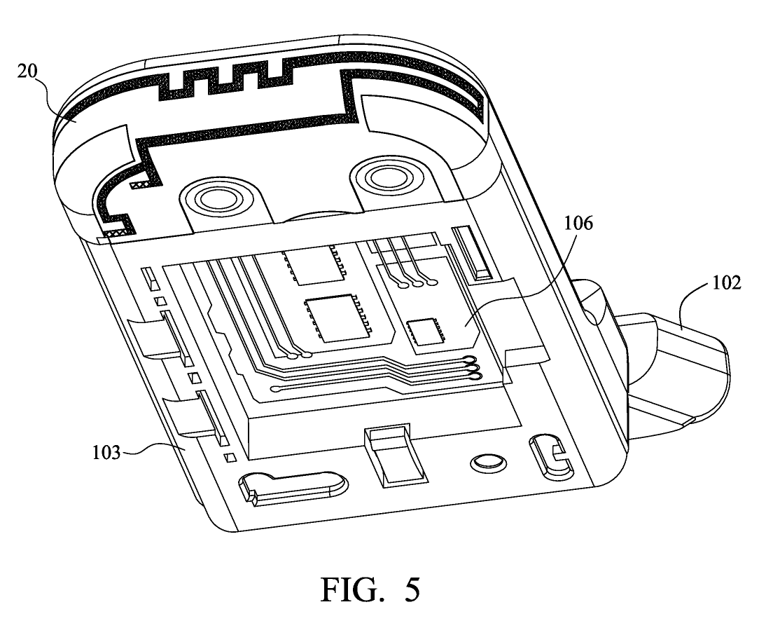

FIG. 5 shows a portable electronic device 100 equipped with the antenna module 20 according to an exemplary embodiment. To reduce the coupling effect between the first antenna 42 and the second antenna 44, the distance between the first antenna 42 and the second antenna 44 is substantially equal to the thickness of the main body 103.

In use, the feed point 46 connects to the main portion 422 of the first antenna 42 by the first connecting portion 424. The first antenna 42 is configured to resonate in frequency bands between approximately 824 MHz to 894 MHz. The second antenna 44 is configured to resonate in frequency bands between approximately 1850 MHz to 1991 MHz. The frequency bands of the antenna 20 may be adjusted by changing the configuration and dimensions of the meandering structure of the coupling section 444 as described above, and/or, for example, changing the number, width, and distance between the inverted-U portions and the distance between the main portion 422 and the coupling section 444. The antenna 20 covers the low frequency band (about 824 to 894 MHz) and high frequency band (about 1850 to 1991 MHz).

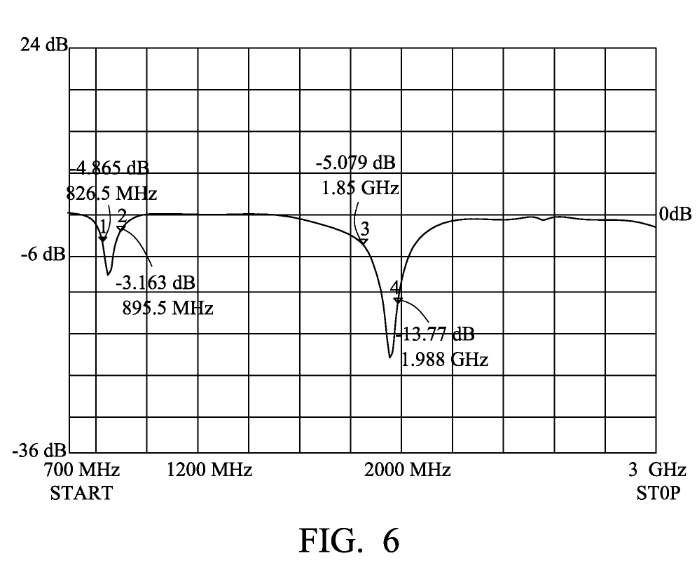

As described in our copending application, Ser. No. 12/185221, filed August, 2008, and incorporated by reference herein, there are frequency shits depending upon whether a flip phone is in its open state or closed state. FIG. 6 of the current application shows return loss measurement for the antenna module of FIG. 5 of the current application in a closed state, wherein the x-axis indicates frequency and the y-axis indicates decibel (dB). The curve represents the frequency characteristics of the first and second antennas 20 in −6 dB return loss. As shown in FIG. 6, in a closed condition, the bandwidth of the first antenna 42 is 69 MHz (about 826.5 to 895.5 MHz), and the return loss is about −4.865 dB to −3.163 dB. The bandwidth of the second antenna 44 is 138 MHz (about 1.85 to 1.988 GHz), and the return loss is about −5.079 dB to −13.77 dB. The antenna 20 can operate in low frequency bands, such as between 824 and 894 MHz and high frequency bands, such as between 1850 and 1991 MHz.

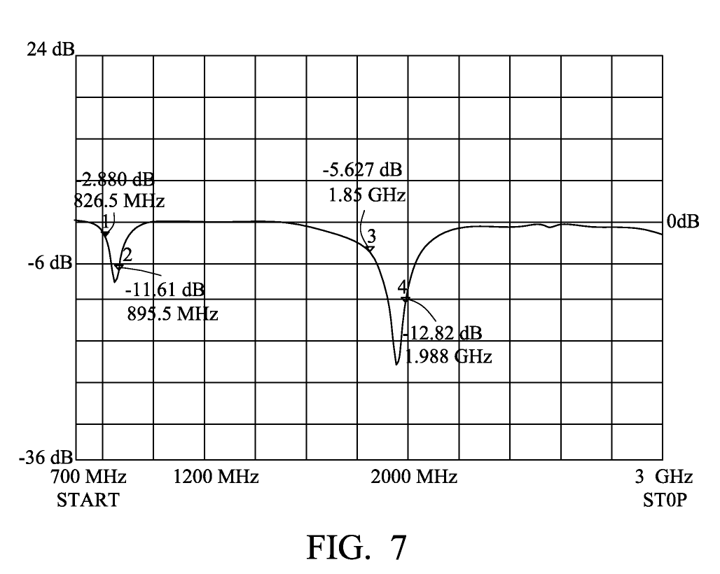

FIG. 7 shows return loss measurement for the antenna module in FIG. 5 in an opened state, wherein the x-axis indicates frequency and the y-axis indicates decibel (dB). The curve represents the frequency characteristics of the first and second antenna 20 in −6 dB return loss. As shown in FIG. 7, in an open condition, the return loss of the first antenna 42 is about −2.880 dB to −11.61 dB. The return loss of the second antenna 44 is about −5.627 dB to −12.82 dB. The antenna 20 can operate at low frequency bands, such as between 824 and 894 MHz and high frequency bands, such as between 1850 and 1991 MHz.

As described above, the antenna module 20 may be used in various operating frequency bands, beyond those of the cellular phone as illustrated, and/or with other devices requiring an antenna module that facilitates the achievement of fully open and fully closed positions.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An antenna module, comprising:
an antenna holder comprising an antenna set, feed point and ground;
the antenna set comprising a first antenna and a second antenna, the first antenna comprising a main section and a connecting portion electrically connecting to the feed point and ground, the second antenna comprising a front section, a coupling section and a bent section connected in series, the bent section connecting to the main section of the first antenna, wherein the first antenna has a first resonant frequency and the second antenna has a second resonant frequency.

2. The antenna module as claimed in claim 1, wherein the connecting portion further comprises a first connecting portion electrically connecting to the main section and the feed point, and a second connecting portion electrically connecting to the first connecting portion and the ground.

3. The antenna module as claimed in claim 2, wherein the bent section and the connecting portion are connected to the main section of the first antenna.

4. The antenna module as claimed in claim 3, wherein the coupling section is a meandering structure providing a coupling effect.

5. The antenna module as claimed in claim 4, wherein the meandering structure of the coupling section comprises periodically U-shaped undulations, the width of each U-shaped portion equals the distance between each U-shaped portion.

6. The antenna module as claimed in claim 1, wherein the first resonant frequency is a low frequency and the second resonant frequency is a high frequency.

7. A portable electronic device, comprising a flip cover and a main body connected to the flip cover, the main body comprising a printed circuit board and an antenna module electrically connected to the print circuit board, wherein the antenna module comprises:
an antenna holder comprising an antenna set, feed point and ground;
the antenna set comprising a first antenna and a second antenna, the first antenna comprising a main section and a connecting portion electrically connecting to the feed point and ground; and the second antenna comprising a front section, a coupling section and a bent section connected in series, the bent section connecting to the main section of the first antenna, wherein the first antenna has a first resonant frequency and the second antenna has a second resonant frequency.

8. The portable electronic device as claimed in claim 7, wherein the connecting portion further comprises a first connecting portion electrically connecting to the main section and the feed point, and a second connecting portion electrically connecting to the first connecting portion and the ground.

9. The portable electronic device as claimed in claim 8, wherein the bent section and the connecting portion are connected to the main section of the first antenna.

10. The portable electronic device as claimed in claim 9, wherein the he coupling section is a meandering structure providing a coupling effect.

11. The portable electronic device as claimed in claim 10, wherein the meandering structure of the coupling section comprises periodically U-shaped undulations and the width of each U-shaped portion equals the distance between each U-shaped portion.

12. The portable electronic device as claimed in claim 7, wherein the first resonant frequency is a low frequency and the second resonant frequency is a high frequency.

13. The portable electronic device as claimed in claim 7, wherein the distance between the first antenna and the second antenna substantially equals the thickness of the main body of the portable electronic device.
